(19) United States
(12) Patent Application Publication
(10) Pub. No.: US 2022/0414740 A1
(43) Pub. Date: Dec. 29, 2022

(54) BUILDING A MARKETPLACE FOR A USER

(71) Applicant: Yellow Birds Retail Private Limited, Bengaluru (IN)

(72) Inventors: Viswanathan Tiruchengode Subramanian, Bommanahali (IN); Vaishnavi Rangarajan, Bommanahali (IN)

(21) Appl. No.: 17/360,351

(22) Filed: Jun. 28, 2021

(51) Int. Cl. G06Q 30/06; G06Q 30/02; G06N 3/08; G06F 16/958

(52) U.S. Cl. CPC G06Q 30/0631; G06Q 30/0201; G06Q 30/0641; G06Q 30/0603; G06N 3/08; G06F 16/958; G06Q 50/01

(57) ABSTRACT

A system for building a marketplace for a user in which the system initially receives a user profile comprising a profession, demographic information, and community information of a user. The system further automatically determines a predefined template based upon the user profile. It may be noted that the predefined template indicates a layout for an e-commerce store. The system then recommends a plurality of products from a catalogue stored in a master store. Further, a set of products are selected from the plurality of products and added to the e-commerce store. The system then links the e-commerce store to a website domain in real time. Finally, the e-commerce store is published on the website domain in order to build a marketplace for the user. The e-commerce store facilitates shopping of the set of products fulfilled by a plurality of sellers.

### PRIORITY INFORMATION

The present application does not claim a priority from any other application.

### TECHNICAL FIELD

The present subject matter described herein, in general, relates to building a marketplace for a user.

### BACKGROUND

E-commerce Industry is growing at a rapid pace. In 2020, retail e-commerce sales worldwide amounted to 4.28 trillion US dollars and e-retail revenues are projected to grow to 5.4 trillion US dollars in 2022. The e-commerce marketplace is a website where one can find different brands of products coming from multiple vendors, shops, or person showcased on the same platform. The e-commerce marketplace acts as a connection between a customer and a seller. Anyone with an access to a computer and an internet may set up the e-commerce marketplace. Usually, the seller uses third-party service providers to host their e-commerce store but, there can be easier ways for an individual to host an online marketplace.

### SUMMARY

Before the present system(s) and method(s), are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for building a marketplace for a user. This summary is not intended to identify essential features of the claimed subject matter nor is it intended for use in determining or limiting the scope of the claimed subject matter.

In one embodiment, a method for building a marketplace for a user is disclosed. Initially, a user profile comprising a profession, demographic information, and community information of a user may be received. Further, a predefined template may be automatically determined based upon the user profile. The predefined template may indicate a layout for an e-commerce store. Further, a plurality of products may be recommended from a catalogue stored in a master store. The plurality of products may be recommended based upon a Deep Learning Model and Neural Network techniques on the demographic information and the community information. It may be noted that the catalogue may be specific to the profession. Subsequently, a set of products may be selected from the plurality of products. Furthermore, the set of products may be added to the e-commerce store. The method may further comprise linking the e-commerce store to a website domain in real time when the website domain is available. Finally, the e-commerce store may be published on the website domain in order to build a marketplace for the user. The e-commerce store may facilitate shopping of the set of products fulfilled by a plurality of sellers. In one aspect, the aforementioned method for building a marketplace for a user may be performed by a processor using programmed instructions stored in a memory.

In another embodiment, a non-transitory computer-readable medium embodying a program executable in a computing device for building a marketplace for a user is disclosed. The program may comprise a program code for receiving a user profile comprising a profession, demographic information, and community information of a user. Further, the program may comprise a program code for automatically determining a predefined template based upon the user profile. The predefined template may indicate a layout for an e-commerce store. Subsequently, the program may comprise a program code for recommending a plurality of products from a catalogue stored in a master store. The plurality of products may be recommended based upon Deep Learning Model and Neural Network techniques on the demographic information and the community information. It may be noted that the catalogue may be specific to the profession. Subsequently, the program may comprise a program code for selecting a set of products from the plurality of products. Further, the program may comprise a program code for adding the set of products to the e-commerce store. Furthermore, the program may comprise a program code for linking the e-commerce store to a website domain in real time when the website domain is available. Finally, the program may comprise a program code for publishing the e-commerce store on the website domain in order to build a marketplace for the user. It may be noted that the e-commerce store facilitates shopping of the set of products fulfilled by a plurality of sellers.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, however, the invention is not limited to the specific method and system for building a marketplace for a user disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation for building a marketplace for a user, in accordance with an embodiment of the present subject matter.

FIG. 2 illustrates a method for building a marketplace for a user, in accordance with an embodiment of the present subject matter.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving,” “determining,” “recommending,” “selecting,” “adding,” “linking,” “publishing,” and other forms thereof, are intended to be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present subject matter discloses a method and a system for building a marketplace for a user. It may be noted that the invention aims to build a marketplace from a master store. The master store may comprise a catalogue comprising a plurality of products. The catalogue is specific to a profession. The system may initially receive a user profile comprising a profession, demographic information, and community information of a user. The system may recommend a plurality of products to the user and then the user may select a set of products from the plurality of products. Further, the user adds a product to an e-commerce store. The system may then link the e-commerce store to a website domain in real time. Finally, the e-commerce store may be published on the website domain thus, creating a marketplace for the user. It may be noted that building the e-commerce store is an extensive activity. The present invention helps to reduce the time and effort required for building the e-commerce store.

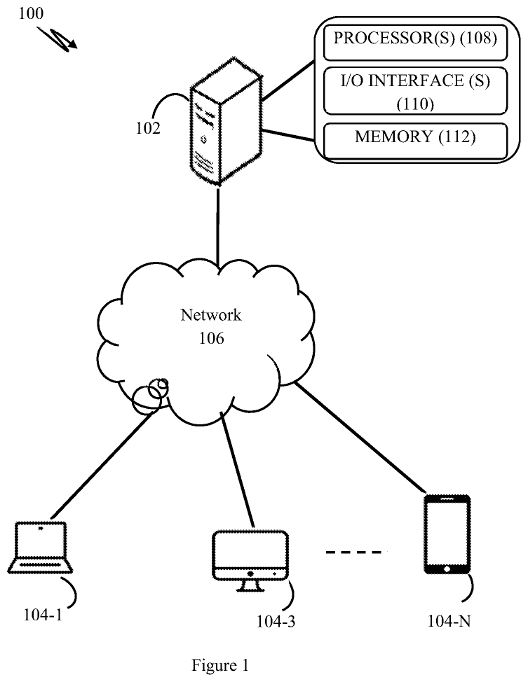

Referring now to FIG. 1, a network implementation 100 of a system 102 for building a marketplace for a user is disclosed. Initially, the system 102 receives a user profile. It may be noted that one or more users may access the system 102 through one or more user devices 104-2, 104-3 . . . 104-N, collectively referred to as user devices 104, hereinafter, or applications residing on the user devices 104. The system 102 receives the user profile from one or more user devices 104. Further, the system may also 102 receive a feedback from a user using the user devices 104.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, a cloud-based computing environment. It will be understood that the system 102 may be accessed by multiple users through one or more user devices 104-1, 104-2 . . . 104-N. In one implementation, the system 102 may comprise the cloud-based computing environment in which the user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network, or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may include at least one processor 108, an input/output (I/O) interface 110, and a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

As there are various challenges observed in the existing art, the challenges necessitate the need to build the system 102 for building a marketplace for a user. At first, the user may use the user device 104 to access the system 102 via the I/O interface 110. The user may register the user devices 104 using the I/O interface 110 in order to use the system 102. In one aspect, the user may access the I/O interface 110 of the system 102. The detail functioning of the system 102 is described below with the help of figures.

The present subject matter describes the system 102 for building a marketplace for a user. The system 102 may receive a user profile comprising a profession, demographic information, and community information of a user. The demographic information may comprise, but not limited to, a location of the user, an education, a profession of the user, and an income. The community information may comprise metadata of community members of the user on a social media platform. The metadata may comprise, but not limited to, links to profiles of the members in the community, an activity of the members on the social media platform, an age group, an occupation, ethnicity, and a geographical area of residence.

Further to receiving, the system 102 may automatically determine a predefined template based upon the user profile. The predefined template may indicate a layout for an e-commerce store. In one embodiment, the layout is made using HTML or CSS technologies. The predefined template may be stored in the memory 112. In an embodiment, the system 102 may comprise a predefined template for each profession. In an embodiment, the system 102 may automatically choose a colour combination of the e-commerce store based on a logo provided by the user. In one example, construe a colour of the logo comprises blue and yellow colours. In the example, the system 102 may change a User Interface (UI) of the e-commerce store to blue and yellow.

Further to determining, the system 102 may recommend a plurality of products from a catalogue stored in a master store. The plurality of products may be recommended based upon a Deep Learning Model and Neural Network techniques on the demographic information and the community information. The catalogue may be specific to the profession. The system 102 may recommend only 100 products to the user based upon the demographic information and the community information. It may be noted that the system 102 is prioritizing 100 products ‘based on the demographic information and the community information. The user may browse through 10000 products. It may be noted that the system 102 is saving the users time by recommending the plurality of products from a catalogue.

In an embodiment, the Deep Learning model may be trained based on the metadata of the community, community members of similar interests, the demographic information, and products being added in a shopping cart present at the e-commerce store, or being browsed, or being actually bought by a customer.

Further to recommending, the user may select a set of products from the plurality of products. In the above example, the user may select 20 products from 100 products. In an embodiment, the user may assign one or more products to a collection. The collection may comprise similar type of products.

Further to selecting, the system 102 may add the set of products to the e-commerce store. In the above example, the user may add 20 products to the e-commerce store. In an embodiment, the user may add the set of products from the master store to the e-commerce store. In another embodiment, the system 102 may keep a track of the type of the product the user is selecting. In other words, the system 102 may learn through the user selection to recommend the plurality of products from a catalogue.

Further to adding, the system 102 may link the e-commerce store to a website domain in real time when the website domain is available. In the above example, let us assume that the website domain is “myecommercestore.com”. The system 102 may link the website domain with the e-commerce store comprising 20 products.

Further to linking, the system 102 may publish the e-commerce store on the website domain in order to build a marketplace for the user. The e-commerce store may facilitate shopping of the set of products fulfilled by a plurality of sellers. In an embodiment, the user may update the e-commerce store by adding new products from the master store. In the above example, the system 102 may publish the e-commerce store comprising 20 products. Further, a customer may buy or browse through these 20 products. It may be noted that e-commerce store uses a payment gateway solution of the master store. When the customer clicks on a checkout button available at the e-commerce store, the customer is directed to the master store payment gateway. In an embodiment, the user may customize the platform by at least modifying colours, fonts, pictures, a price of a product, text, and alike.

Consider an example, the system 102 may receive a user profile comprising a profession, demographic information, and community information of a user. Let us assume that the profession is “Guitar Teacher.” Further, the system 102 may automatically determine a predefined template based upon the user profile. Subsequently, the system 102 may recommend a plurality of products from a catalogue stored in a master store. It may be noted that the system 102 may recommend products like Acoustic Guitar, Ukulele, and Guitar Accessories. The products may be recommended based upon a Deep Learning Model and Neural Network techniques on the demographic information and the community information. It may be noted that the catalogue comprises Acoustic Guitar, Electric Guitar, Bass Guitar, Ukulele, and Guitar Accessories. The system may recommend Acoustic Guitar, Ukulele, and Guitar Accessories and discards products like Electric Guitar, Bass Guitar. It may be noted that the system may understand from the user profile that the Guitar Teacher is not teaching Electric Guitar and Bass Guitar. Further to recommending, the user may select a set of products from the plurality of products. In the example, the user may select and assign the one or more products to a collection. In the example, the user may create a collection for acoustic guitar, guitar accessories, and ukuleles. Subsequently, the user may add the set of products to the e-commerce store (Guitar Store). Further, the system may recommend website domains to the user when the website domain is not available. Further, the user may buy the website domain. Subsequently, the website domain may be linked to the e-commerce store. Finally, the e-commerce store (Guitar Store) may be published on the website domain in order to build a marketplace for the user (Guitar Teacher).

In an embodiment, the system 102 may recommend one or more products to the user based on the social media activity of the user. It may be noted that the Deep Learning Model may be used for recommending the one or more products to the user over a period. Consider an example, the user has published an e-commerce store. The system may automatically recommend the one or more products to the user after a month, or a quarter based on the user's social media activity. In another embodiment, the system 102 may recommend offering discount or deals on some products available at the e-commerce store based on the social media activity of the user.

In one embodiment, the system 102 may identify gaps in catalogue based on the social media activity of one or more users. Further, the system 102 may recommend brands or products or product categories to be added to the catalogue stored in the master store. In one example, the system 102 may recommend brands or products to be added to the catalogue based on the conversations in social media communities. It may be noted that the gap is identified by using a combination of the Deep Learning model. Consider an example, the trending product category in one or more communities are related to beard grooming product. The system 102 may check whether beard grooming products are present in the catalogue. If the beard grooming products are not present, the system 102 may recommend top brands and top products related to the beard grooming category to add to the catalogue. It may be noted that the catalogue may be updated continuously. Further, the system uses a combination of the Deep Learning Model, Machine Learning to recommend the brands or the products or the product categories to be added to the catalogue.

In an embodiment, the e-commerce store is linked to the master store. The master store is responsible for providing payment gateway solution, delivery services, marketing, and advertising services to the e-commerce store. Consider an example, a customer buys a product from the e-commerce store. The delivery and all other services may be fulfilled by the master store. It may be noted that the user (e-commerce store owner) does not own any products. The user only creates the e-commerce store from the list of products available at the master store. In another embodiment, the master store may be updated by adding or removing one or more products from the catalogues.

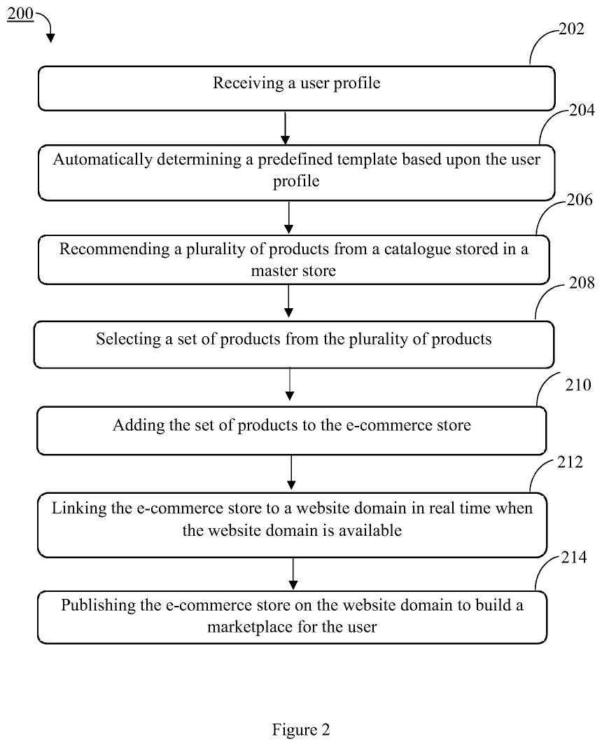

Referring now to FIG. 2, a method 200 for building a marketplace for a user is shown, in accordance with an embodiment of the present subject matter. The method 200 may be described in the general context of computer executable instructions. Generally, computer executable instructions can include routines, programs, objects, components, data structures, procedures, modules, functions, etc., that perform particular functions or implement particular abstract data types.

The order in which the method 200 is described is not intended to be construed as a limitation, and any number of the described method blocks can be combined in any order to implement the method 200 or alternate methods for building a marketplace for a user. Additionally, individual blocks may be deleted from the method 200 without departing from the scope of the subject matter described herein. Furthermore, the method 200 for building a marketplace for a user can be implemented in any suitable hardware, software, firmware, or combination thereof. However, for ease of explanation, in the embodiments described below, the method 200 may be considered to be implemented in the above-described system 102.

At block 202, a user profile comprising a profession, demographic information, and community information of a user may be received.

At block 204, a predefined template may be automatically determined based upon the user profile. The predefined template may indicate a layout for an e-commerce store.

At block 206, a plurality of products may be recommended from a catalogue stored in a master store. The plurality of products is recommended based upon Deep Learning Model and Neural Network techniques on the demographic information and the community information.

At block 208, a set of products may be selected from the plurality of products.

At block 210, the set of products may be added to the e-commerce store.

At block 212, linking the e-commerce store to a website domain in real time when the website domain is available.

At block 214, the e-commerce store may be published on the website domain in order to build a marketplace for the user. The e-commerce store facilitates shopping of the set of products fulfilled by a plurality of sellers.

Exemplary embodiments discussed above may provide certain advantages. Though not required to practice aspects of the disclosure, these advantages may include those provided by the following features.

Some embodiments of the system and method enables to create an e-commerce store from a master store.

Some embodiments of the system and method provides a marketplace as a service.

Some embodiments of the system and method enables automatic creation of the e-commerce store for a user with community following.

Some embodiments of the system and method reduces time of the user to create the e-commerce store.

Some embodiments of the system and method enables creation of customized e-commerce store for the user.

Although implementations for methods and system for building a marketplace for a user have been described in language specific to structural features and/or methods, it is to be understood that the appended claims are not necessarily limited to the specific features or methods described. Rather, the specific features and methods are disclosed as examples of implementations for building a marketplace for a user.

We claim:

1. A system for building a marketplace for a user, the system comprises:
a memory; and
a processor coupled to the memory, wherein the processor is configured for:
receiving a user profile comprising a profession, demographic information, and community information of a user;
automatically determining a predefined template based upon the user profile, wherein the predefined template indicates a layout for an e-commerce store;
recommending a plurality of products from a catalogue stored in a master store, and wherein the plurality of products is recommended based upon a Deep Learning Model and Neural Network techniques on the demographic information and the community information, and wherein the catalogue is specific to the profession;
selecting a set of products from the plurality of products;
adding the set of products to the e-commerce store;
linking the e-commerce store to a website domain in real time when the website domain is available; and
publishing the e-commerce store on the website domain in order to build a marketplace for the user, wherein the e-commerce store facilitates shopping of the set of products fulfilled by a plurality of sellers.

2. The system as claimed in claim 1, the demographic information comprises a location of the user, an education, a profession of the user, and an income.

3. The system as claimed in claim 1, wherein the community information comprises metadata of community members of the user on a social media platform, wherein the metadata comprises links to profiles of the members in the community, an activity of the members on the social media platform, an age group, an occupation, ethnicity, and a geographical area of residence.

4. The system as claimed in claim 1, further comprising recommending the website domain when the website domain is not available.

5. The system as claimed in claim 1, wherein the Deep Learning model is trained based on the metadata of the community, community members of similar interests, demographic information, and products being added in a shopping cart present at the e-commerce store, or being browsed, or being actually bought by a customer.

6. The system as claimed in claim 1, wherein the system automatically chooses the colour combination of the e-commerce store based on a logo provided by the user.

7. The system as claimed in claim 1, further comprises customizing the platform by at least modifying colours, fonts, pictures, a price of a product, text, and alike.

8. The system as claimed in claim 1, further comprises assigning the one or more products to a collection, wherein the collection comprises similar type of products.

9. The system as claimed in claim 1, further comprises updating the e-commerce store by adding new products from the master store.

10. A method for building a marketplace for a user, the method comprises:
receiving, by a processor, a user profile comprising a profession, demographic information, and community information of a user;
automatically determining, by the processor, a predefined template based upon the user profile, wherein the predefined template indicates a layout for an e-commerce store;
recommending, by the processor, a plurality of products from a catalogue stored in a master store, and wherein the plurality of products is recommended based upon Deep Learning Model and Neural Network techniques on the demographic information and the community information, and wherein the catalogue is specific to the profession;
selecting, by the processor, a set of products from the plurality of products;
adding, by the processor, the set of products to the e-commerce store;
linking, by the processor, the e-commerce store to a website domain in real time when the website domain is available;
publishing, by the processor, the e-commerce store on the website domain in order to build a marketplace for the user, wherein the e-commerce store facilitates shopping of the set of products fulfilled by a plurality of sellers.

11. A non-transitory computer program product having embodied thereon a computer program for building a marketplace for a user, the computer program product storing instructions, the instructions for:
receiving a user profile comprising a profession, demographic information, and community information of a user;
automatically determining a predefined template based upon the user profile, wherein the predefined template indicates a layout for an e-commerce store;
recommending a plurality of products from a catalogue stored in a master store, and wherein the plurality of products is recommended based upon Deep Learning Model and Neural Network techniques on the demographic information and the community information, and wherein the catalogue is specific to the profession;
selecting a set of products from the plurality of products;
adding the set of products to the e-commerce store;
linking the e-commerce store to a website domain in real time when the website domain is available;
publishing the e-commerce store on the website domain in order to build a marketplace for the user, wherein the e-commerce store facilitates shopping of the set of products fulfilled by a plurality of sellers.
